(19) United States
(12) Patent Application Publication
(10) Pub. No.: US 2026/0297237 A1
(43) Pub. Date: Oct. 1, 2026

(54) SCRATCH-RESISTANT INTERPENETRATING POLYMER NETWORKS AND METHODS OF MAKING THE SAME

(71) Applicant: Saudi Arabian Oil Company, Dhahran (SA)

(72) Inventors: Yassine Malajati, Beachwood, OH (US); Aziz Fihri, Paris (FR); Noor Alsakhin, Al Qatif (SA)

(73) Assignee: Saudi Arabian Oil Company, Dhahran (SA)

(21) Appl. No.: 19/093,839

(22) Filed: Mar. 28, 2025

(51) Int. Cl. C08F 292/00; C08K 3/36

(52) U.S. Cl. CPC C08F 292/00; C08K 3/36; C08K 2201/005; C08K 2201/011

(57) ABSTRACT

A method includes preparing a silane-containing sol-gel to provide a filler, preparing a first solution comprising a polymer and an organic solvent, adding the silane-containing sol-gel and a curing agent to the first solution to form a second solution, and maintaining the second solution for a period of time such that an amount of the organic solvent evaporates, thereby forming a polymer composite matrix. A composition includes a semi-interpenetrating polymer network, and a filler embedded in the semi-interpenetrating polymer network. The composition is a reaction product of a silane-containing sol-gel, a polymer, and a curing agent.

### BACKGROUND

Composite materials have a wide range of applications due to a combination of properties and attributes that cannot be achieved by metals, ceramics, or polymers alone. Polycarbonate (PC) and poly(methyl methacrylate) (PMMA) have been broadly investigated for applied and fundamental research due to their distinct set of properties, including high optical properties, impact resistance and rigidity, either as single-phase materials or as matrices of composite materials. The optical clarity of these two polymers is remarkably high among common thermoplastics. For this reason, these two polymers have been exhaustively exploited in several applications, including electronic devices, automotive, safety equipment, architecture, and aerospace.

Numerous studies have focused on improving the properties of transparent polymers using fillers and reinforcements to extend their applications without affecting their transparency. In this context, the thermal and mechanical properties of polycarbonate and poly(methyl methacrylate) have been investigated in combination with the addition of various nano-fillers, such as graphene sheets, polyhedral oligomeric silsesquioxane (POSS), hydrophobic silica dispersions, short glass fibers, short carbon fibers, TiO₂, Al₂O₃, Zno, ZnS, CdS, and HdS. However, most of these composites have a number of limitations, including limited filler dispersion, poor scratch resistance, and limited dimensional stability. Accordingly, there exists a need for an improved approach to prepare composites with optimized filler dispersion, enhanced scratch resistance, and improved dimensional stability.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method. The method may include preparing a silane-containing sol-gel to provide a filler, preparing a first solution comprising a polymer and an organic solvent, adding the silane-containing sol-gel and a curing agent to the first solution to form a second solution, and maintaining the second solution for a period of time such that an amount of the organic solvent evaporates, thereby forming a polymer composite matrix.

In another aspect, embodiments disclosed herein relate to a composition. The composition may include a semi-interpenetrating polymer network, and a filler embedded in the semi-interpenetrating polymer network. The composition may be a reaction product of a silane-containing sol-gel, a polymer, and a curing agent.

Other aspects and advantages of the claimed subject matter will be apparent from the following description and the appended claims.

### BRIEF DESCRIPTION OF DRAWINGS

FIG. 1A is a schematic of a method in accordance with one or more embodiments.

FIG. 1B is a schematic of a method in accordance with one or more embodiments.

FIG. 2 is a flowchart of a method in accordance with one or more embodiments.

### DETAILED DESCRIPTION

In one aspect, embodiments disclosed herein relate to a composition and method of making a polymer composite matrix with enhanced scratch resistance and dimensional stability. The composition may include a semi-interpenetrating polymer network and a filler embedded in the semi-interpenetrating network. The composition may be a reaction product of a silane-containing sol-gel, a polymer, and a curing agent. The method for preparing a polymer composite matrix may be a multi-step process, which may include sol-gel reactions, to form the semi-interpenetrating polymer network (IPN). The IPN may have a dual functionality with an improved dimensional stability (due to an interpenetrating network structure) and an improved dispersion of a filler in the IPN (due to an in-situ generation of the filler particles by sol-gel reactions and intermolecular interactions). Embodiments of the present disclosure may be prepared at low temperatures using advanced composites with enhanced properties through the formation of hybrid interpenetrating network systems.

### Composition for a Polymer Composite Matrix

A composition, according to one or more embodiments, includes a semi-interpenetrating polymer network and a filler embedded in the semi-interpenetrating network. The composition may be a reaction product of a silane-containing sol-gel, a polymer and a curing agent. The semi-interpenetrating network may have an in-situ formation of filler particles. The in-situ formation of filler particles may result in an improved distribution of the filler particles within the semi-interpenetrating network. The improved distribution may result in the enhanced scratch resistance and dimensional stability.

The composition may be the reaction product of various reactants including a silane-containing sol-gel. The silane-containing sol-gel may be formed from a precursor. The precursor may be a silane-based precursor. In one or more embodiments, the precursor is selected from 3-glycidyloxypropyltrimethoxysilane, (3-glycidyloxypropyl)triethoxysilane, or diethoxy(3-glycidyloxypropyl)methylsilane. In one or more embodiments, the precursor includes an epoxy group. The epoxy group is critical for forming the semi-interpenetrating network based on a reaction of the epoxy group and an amine group in an amine curing agent. The silane-containing sol-gel may be formed in the presence of a solvent. The solvent may be a suitable solvent for dissolving the precursor. For example, the solvent may be isopropyl alcohol, ethanol, methanol, and combinations thereof.

The composition may be the reaction product of various reactants including a polymer. The polymer may be a transparent polymer. Transparent polymers may be used based on their known properties of optical clarity, impact resistance, and rigidity. The polymer may be poly(methyl methacrylate) (PMMA), polycarbonate (PC), polystyrene, polyethylene terephthalate (PET), and combinations thereof.

The composition may be the reaction product of various reactants including a curing agent. As used throughout this disclosure, the term “cure” or “curing,” when used in the context of the polymer composite matrix refers to the process of crosslinking the polymer and the silane-containing sol-gel, which is in a liquid form initially, with a curing agent to form a solid cured polymer composite matrix. The curing agent may be an amine curing agent. The curing agent may include at least one amine group. The term “amine” as used refers to primary, secondary, and tertiary amines having, for example, the formula N(group)₃, where each ‘group’ can independently be H or non-H, such as alkyl and aryl. Amines include, but are not limited to, R—NH₂, for example, alkylamines, arylamines, alkylarylamines; R₂NH, where each R is independently selected, such as dialkylamines, diarylamines, arylalkylamines, and heterocyclylamines; and R₃N, where each R is independently selected, such as trialkylamines, dialkylarylamines, alkyldiarylamines, and triarylamines.

The curing agents with at least one amine group may include, but are not limited to, an amine, polyamine, amine adduct, polyamine adduct, alkanolamine, phenalkamines, or a combination of these. Examples of amine or polyamine curing agents may include, but are not limited to, aliphatic amines; cycloaliphatic amines; modified cycloaliphatic amines, such as cycloaliphatic amines modified by polyacrylic acid; aliphatic polyamines; cycloaliphatic polyamines; modified polyamines, such as polyamines modified by polyacrylic acid; or amine adducts, such as cycloaliphatic amine adducts and polyamine adducts.

In one or more embodiments, a diamine curing agent may be used. Non-limiting examples of diamine curing agents are aliphatic amines, such as triethylenetetramine or diethylenetriamine (DETA), aromatic amines, such as m-phenylenediamine (MDP) or methylenedianiline (MDA), and cycloaliphatic amines, such as isophorone diamine (IPDA). Such diamines may be used alone or in combination.

The reaction product of the silane-containing sol-gel, the polymer, and the curing agent of one or more embodiments may have a semi-interpenetrating polymer network. The semi-interpenetrating polymer network may include a plurality of covalent linkages (or “crosslinks”) of at least one functional group of the polymer, the silane-containing sol-gel, the amine curing agent, and combinations thereof. Examples of the plurality of covalently linked functional groups may be derived from epoxide rings, cyclic carbonate rings, amine groups, and combinations thereof.

The reaction product may include the semi-interpenetrating polymer network with a filler embedded. The filler may be embedded in the semi-interpenetrating polymer network due to an in-situ formation of the particles within the composition. In one or more embodiments, the filler is silica particles. The filler may have a particle size ranging from 10 to 400 nm. For example, the filler may have a particle size with a lower limit of one of any of 10, 50, 100, 150, and 200 nm with an upper limit of one of any of 200, 250, 300, 350, and 400 nm, where any lower limit may be combined with any mathematically compatible upper limit.

The reaction product, once cured, may have an enhanced scratch resistance. Scratch resistance may be measured by methods known for testing a material for hardness. An example method may be ASTM D3363-05 (“Film hardness by pencil test”). The polymer composite matrix may have a scratch resistance equal to or greater than a hardness of H as determined by ASTM D3363-05.

### Method for Forming a Polymer Composite Matrix

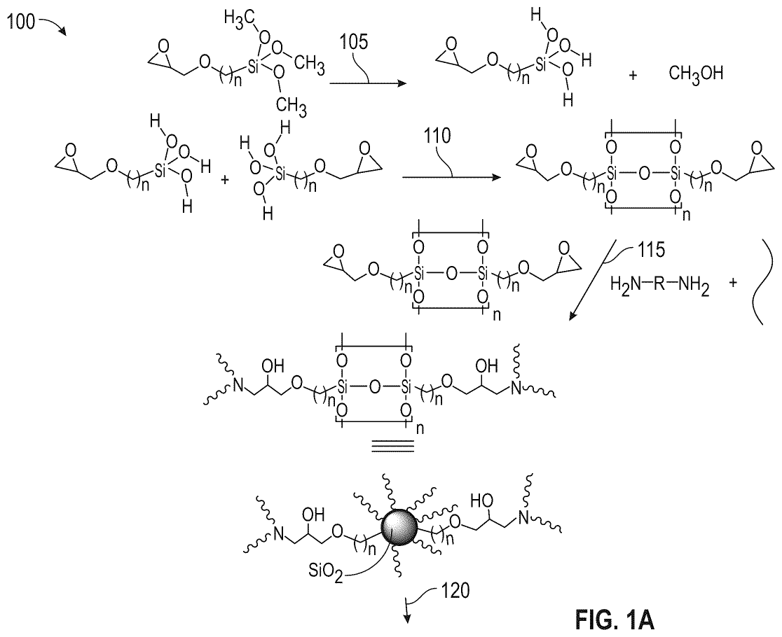

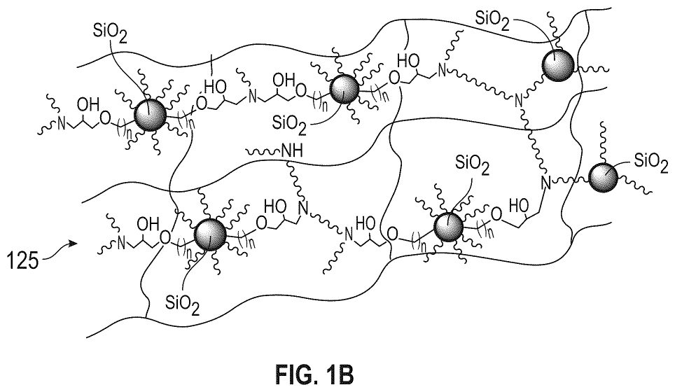

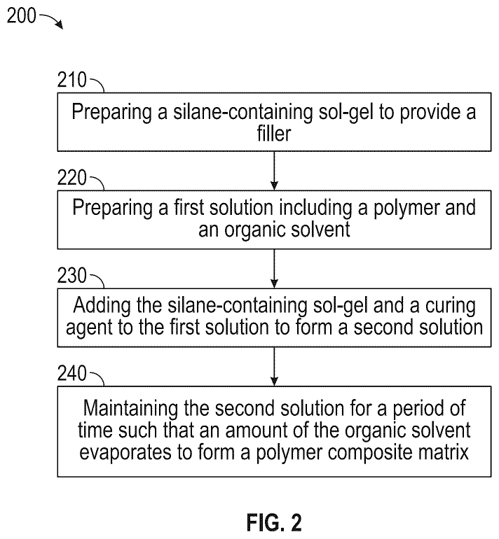

FIG. 1A and FIG. 1B are schematics of a method according to one or more embodiments. FIG. 2 is a flowchart of the method as shown in FIG. 1A and FIG. 1B, according to one or more embodiments. The method 200 includes, at block 210, preparing a silane-containing sol-gel to provide a filler. Preparing the silane-containing sol-gel may include dissolving a precursor in a solvent. The precursor may be a silane-based precursor as explained above. The solvent may be a suitable solvent for dissolving the precursor and may be as discussed above. The precursor may be dissolved in the solvent in a concentration ranging from 10 to 40 mol %.

Once dissolved, preparing the silane-containing sol-gel to provide the filler may include reacting the precursor with a catalyst. The catalyst may initiate hydrolysis in the precursor, as shown by arrow 105 in schematic 100. The catalyst may be an acid. For example, the catalyst may be hydrochloric acid. The catalyst may be reacted with the precursor at a concentration ranging from 0.1 to 0.4 mol %.

After hydrolysis, preparing the silane-containing sol-gel may include condensing the hydrolyzed precursor, as shown by arrow 110. The condensation step may form water molecules using —H and —OH groups supplied from the hydrolyzed precursor in the silane-containing sol-gel. Condensation of the hydrolyzed precursor may lead to the formation of a Si—O—Si repeating structure known in silica particles. In one or more embodiments, silica particles are the filler.

Preparing the silane-containing sol-gel may include agitating after condensing at room temperature for a period ranging from 24 to 48 hours then heating at a temperature ranging from 60 to 80° C. for a period of 1 to 2 hours to yield the silane-containing sol-gel. Agitating may occur using mechanical stirring. Heating may occur by any suitable means, such as, for example, in an oven or by a hot plate. After the silane-containing sol-gel is prepared, the excess solvent may be evaporated from the silane-containing sol-gel in a vacuum oven at 40° C. The silane-containing sol-gel may be stored at a temperature ranging from −50° C. to 0° C. prior to use in the polymer composite matrix.

The method 200 includes, at block 220, preparing a first solution including a polymer and an organic solvent. The polymer may be poly(methyl methacrylate) (PMMA), polycarbonate, polystyrene, polyethylene terephthalate (PET), and combinations thereof. The organic solvent may be a suitable organic solvent used for dissolving the polymer. For example, the organic solvent may be chloroform or dichloromethane. The polymer may be present in the first solution in an amount ranging from 0.05 to 0.1 grams per milliliter (g/mL). The polymer may be dissolved in the organic solvent at room temperature to prepare the first solution.

The method 200 includes, at block 230, adding the silane-containing sol-gel and a curing agent to the first solution to form a second solution. In one or more embodiments, the silane-containing sol-gel and curing agent are added simultaneously to the first solution, as shown by arrow 115. In other embodiments, the silane-containing sol-gel and the first solution are combined prior to adding the curing agent. A reaction of the amines in the curing agent with the epoxy groups in the silane-containing sol-gel may occur in presence of the polymer in the first solution in order to form the three-dimensional network of the semi-interpenetrating network.

The silane-containing sol-gel and the curing agent may be added to the first solution to form a second solution. Adding the silane-containing sol-gel and the curing agent to the polymer of the first solution may lead to the formation of particles in situ. The particles may serve as a filler. The in-situ formation of particles may serve to improve the dimensional stability in the polymer composite matrix. The filler particles may be chemically bonded and well-dispersed in the polymer composite matrix due to the in-situ formation. The in-situ formation may improve the filler dispersion in the polymer composite matrix. The dispersion may be improved because the filler is allowed to interact with the polymer through intermolecular reactions such as hydrogen-bonding and Van der Waals forces. Adding the curing agent may crosslink bonds with the silane-containing sol-gel (more specifically epoxy groups). The crosslinked bonds may lead to the formation of a solid cured polymer composite matrix 125, as shown by arrow 120. This matrix allows for a large number of intermolecular interactions (e.g., hydrogen bonding and Van de Waals forces) between the silica particles and the polymer matrix. The silane-containing sol-gel may be added to the first solution in an amount ranging from 0.5 to 5.0 percent by volume (vol %). The curing agent may be added to the first solution in an amount ranging from 2.5 to 5.0 vol %.

The method 200 includes, at block 240, maintaining the second solution for a period of time such that an amount of the organic solvent evaporates to form a polymer composite matrix. Maintaining the second solution may include agitating the second solution for a first period of time. The first period of time may range from 8 to 12 hours. The second solution may be agitated at room temperature during the first period of time.

Maintaining the second solution may then include evaporating the organic solvent from the second solution such that an amount of the organic solvent evaporates to form a polymer composite matrix. The amount of organic solvent evaporated may range from 90 to 100%. The organic solvent may be evaporated for a second period of time. The second period of time may range from 24 to 96 hours.

The polymer composite matrix may have an enhanced scratch resistance. Scratch resistance may be measured by methods known to test a material for hardness. An example method may be ASTM D3363-05 (“Film hardness by pencil test”). The method may include using a pencil scratch tester with a mechanical load of 500 grams, a pencil angle of 45°, and a scratch speed of 1 millimeter per second. The polymer composite matrix may have a scratch resistance equal to or greater than a hardness of H as determined by ASTM D3363-05.

Embodiments of the present disclosure may provide at least one of the following advantages. The polymer composite matrix according to the present disclosure may be prepared by a multi-step process, which may include sol-gel reactions, to form the IPN. The IPN may have a dual functionality with an improved dimensional stability where the improved dimensional stability is due to the interpenetrating network structure. The IPN may have a dual functionality with an improved dispersion of a filler in the IPN where the improved dispersion is due to the in-situ generation of the filler particles by sol-gel reactions and intermolecular interactions. Methods known in the art are known to have aggregation of the filler particles due to in-situ polymerization of the polymer when forming the IPN. Methods described herein form the polymer prior to the formation of the IPN. Further, the filler particles are formed in situ, which improves the dispersion.

Further advantages include better ability to control the molecular weight of the polymer prior to formation of the IPN. Methods known in the art form the polymer in situ with the IPN. This leads to a reduced control over the molecular weight of the polymer. Forming the polymer prior to the IPN, as described herein, results in a better control over the molecular weight of the polymer, where the molecular weight may affect the scratch resistance. Embodiments of the present disclosure may further be prepared at low temperatures using advanced composites with enhanced properties through the formation of hybrid interpenetrating network systems.

### EXAMPLES

### Example 1: Preparation of 3-glycidyloxypropyltrimethoxysilane sol

4.7 milliliters (mL) of 3-glycidyloxypropyltrimethoxysilane (GPTMS) substrate was dissolved in 5.3 mL of isopropyl alcohol (IPA) containing 1.3 mL of 0.2 M HCl used as a catalyst and stirred at room temperature for 30 hours. The resulting solution was then heated at 65° C. for 1 hour. The IPA was removed in vacuum oven at 40° C. A colorless homogeneous solution was obtained after the hydrolysis of GPTMS, which then was stored in the freezer leading to a viscous transparent solution.

### Example 2: Preparation of PMMA Composites

Two solutions were prepared by dissolving 4 grams of poly(methyl methacrylate) (PMMA) in 40 mL of chloroform at room temperature. Then, the previously prepared GPTMS sol and 3-aminomethyl-3,5,5-trimethylcyclhexylamine (IPDA) were added to the above PMMA solutions to make the PMMA composite solutions in the following amounts:
a. Modified sample 1: the first PMMA composite solution contained 1 mL IPDA with 0.2 mL GPTMS sol, and
b. Modified sample 2: the second PMMA composite solution contained 2 mL IPDA with 0.4 mL GPTMS sol.
   The solutions were stirred overnight and poured into Teflon molds of dimensions 8 cm×6.3 cm×4 cm then placed in a sealed glass container with a narrow opening at the top for the solvent to slowly evaporate for three days.

### Example 3: Scratch Tests

The scratch tests of the samples were conducted using pencil scratch tester according to ASTM D3363-05 with a load of 500 grams, pencil angle of 45° and scratch speed of 1 millimeter per second (mm/s). The scratch test results are displayed in Table 1.

TABLE 1
Pencil Scratch resistance levels
of pure PMMA vs. modified samples

| Samples | Scratch resistance |
|---|---|
| Unmodified PMMA | 3B |
| Modified sample 1 (1 mL IPDA, 0.2 mL Sol) | H |
| Modified sample 2 (2 mL IPDA, 0.4 mL Sol) | 3H |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method comprising:
preparing a silane-containing sol-gel to provide a filler;
preparing a first solution comprising a polymer and an organic solvent;
adding the silane-containing sol-gel and a curing agent to the first solution to form a second solution; and
maintaining the second solution for a period of time such that an amount of the organic solvent evaporates, thereby forming a polymer composite matrix.

2. The method of claim 1, wherein preparing the silane-containing sol-gel comprises reacting a precursor with a catalyst.

3. The method of claim 2, wherein the precursor is 3-glycidyloxypropyltrimethoxysilane, (3-glycidyloxypropyl)triethoxysilane, or diethoxy(3-glycidyloxypropyl)methylsilane.

4. The method of claim 2, wherein the catalyst is hydrochloric acid.

5. The method of claim 1, wherein the polymer is selected from the group consisting of poly(methyl methacrylate), polycarbonate, polystyrene, polyethylene terephthalate (PET), and combinations thereof.

6. The method of claim 1, wherein preparing the first solution comprises adding the polymer at a concentration ranging from 0.05 to 0.1 g/mL.

7. The method of claim 1, wherein the organic solvent is chloroform or dichloromethane.

8. The method of claim 1, wherein adding the silane-containing sol-gel to the first solution comprises adding the silane-containing sol-gel at a concentration ranging from 0.5 to 5 vol %.

9. The method of claim 1, wherein the curing agent is selected from the group consisting of triethylenetetramine, diethylenetriamine, m-phenylenediamine, methylenedianiline, isophorone diamine, and combinations thereof.

10. The method of claim 1, wherein adding the curing agent to the first solution comprises adding the curing agent at a concentration ranging from 2.5 to 5.0 vol %.

11. The method of claim 1, wherein maintaining comprises agitating the second solution for a first period of time ranging from 8 to 12 hours then allowing the organic solvent for a second period of time to evaporate at room temperature.

12. The method of claim 1, wherein the polymer composite matrix has a scratch resistance equal to or greater than a hardness of H as determined by ASTM D3363-05.

13. A composition comprising:
a semi-interpenetrating polymer network; and
a filler embedded in the semi-interpenetrating polymer network,
wherein the composition is a reaction product of a silane-containing sol-gel, a polymer and a curing agent.

14. The composition of claim 13, wherein the filler comprises silica particles.

15. The composition of claim 14, wherein the silane-containing sol-gel comprises 3-glycidyloxypropyltrimethoxysilane.

16. The composition of claim 13, wherein the polymer is poly(methyl methacrylate).

17. The composition of claim 13, wherein the curing agent is selected from the group consisting of triethylenetetramine, diethylenetriamine, m-phenylenediamine, methylenedianiline, isophorone diamine, and combinations thereof.

18. The composition of claim 13, wherein the filler has a particle size ranging from 10 to 400 nm.

19. The composition of claim 13, wherein the reaction product has a scratch resistance equal to or greater than a hardness of H as determined by ASTM D3363-05.
